(19) United States
(12) Patent Application Publication
(10) Pub. No.: US 2018/0144279 A1
(43) Pub. Date: May 24, 2018

(54) NETWORK SEPARATOR FOR TRANSPORTATION RESOURCE PLANNING

(71) Applicant: SAP SE, Walldorf (DE)

(72) Inventors: Leiyi Yao, Shanghai (CN); Xin Chen, Shanghai (CN); Likun Hou, Shanghai (CN)

(21) Appl. No.: 15/359,380

(22) Filed: Nov. 22, 2016

(51) Int. Cl. G06Q 10/06; G06Q 10/08

(52) U.S. Cl. CPC G06Q 10/06313; G06Q 10/083

(57) ABSTRACT

In a network separator in transportation resource planning, a node table and an arc table corresponding to a network graph, and partition criteria are received as input. The network graph is preliminary processed to remove nodes with a defined minimum degree. In pre-processing, the nodes with the defined minimum degree are removed from the network graph using branch-removal technique. The preliminary processed network graph is input to a network partition solver. The network graph is partitioned into multiple partitions. The partitions represent sub-graphs. The network graph is subsequently processed to append the removed nodes. The removed nodes are appended to the network graph using branch-recovery technique. The network graph is partitioned into multiple sub-graphs. An output table is generated with partition identifiers and corresponding node identifiers.

### FIELD

Illustrated embodiments generally relate to data processing, and more particularly to network separator for transportation resource planning.

### BACKGROUND

Intermodal freight transport involves transportation of freight in an intermodal container or vehicle, using multiple modes of transportation such as rail, ship, truck, etc. Containerization is a system of intermodal freight transport using intermodal containers. Containerization of freight transport includes activities such as loading and unloading, standardization of shipments, and handling equipment. In global transportation, major portion of transport is based on train or ocean, and the remaining portion of transport is based on trucks. Because various modes of transport have their own schedules and features, such as capacity, speed, cost, etc., route planning in the intermodal network is complex, and time consuming. Any modification to the intermodal network, may result in re-computing the route and the schedules associated with the transportation completely. This may also result in customers waiting for several hours or days for route generation. Thus it is challenging to build intermodal routes that can be dynamically modified, and computed at a faster pace.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is block diagram illustrating high-level components in network separator for transportation resource planning, according to one embodiment.

FIG. 2 is network graph corresponding to a global transportation network, according to one embodiment.

FIG. 3 illustrates input table set including an input node table and an input arc table in transport resource planning, according to one embodiment.

FIG. 4 is a code snippet illustrating network partition solver, according to one embodiment.

FIG. 5 is exemplary network graph illustrating partitions, according to one embodiment.

FIG. 6 is output table illustrating partition of the graph, according to one embodiment.

FIG. 7 is a flow chart illustrating applying network partition algorithm to nodes, according to one embodiment.

FIG. 8 is a flow chart illustrating network separator in transportation resource planning, according to one embodiment.

FIG. 9 is a block diagram illustrating an exemplary computer system, according to one embodiment.

### DETAILED DESCRIPTION

Embodiments of techniques for network separator for transportation resource planning are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

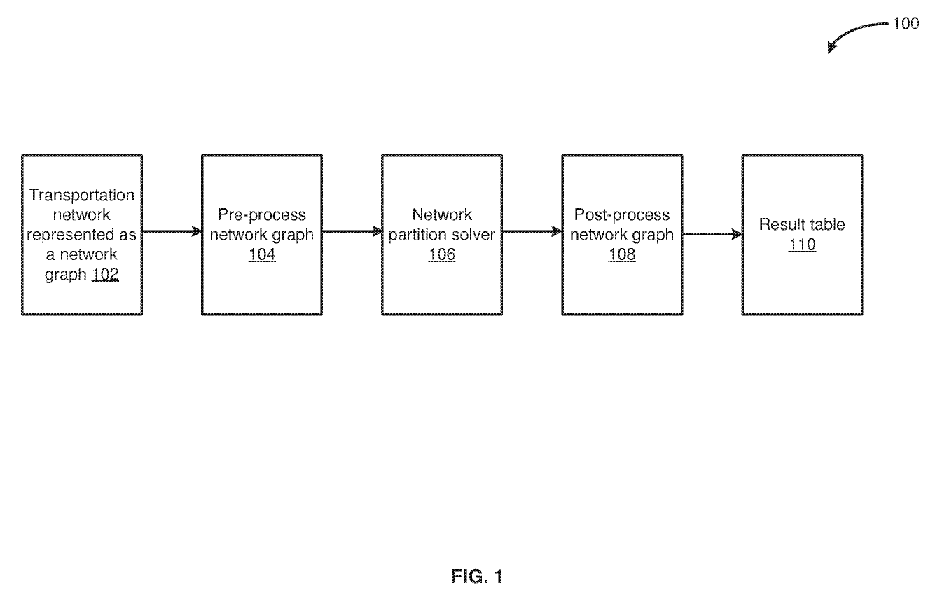

FIG. 1 is block diagram 100 illustrating high-level components in network separator for transportation resource planning, according to one embodiment. In intermodal freight transport, the transportation of freight between various locations is by using multiple modes of transportation such as rail, ship, truck, etc. In global transportation, freight transportation is performed between various locations across the globe. Locations may include depot, harbors, cities, etc. Certain locations may be connected through oceanic vessel, while certain other locations may be connected through train and truck. Locations and the connectivity between these locations form a global transportation network. In the global transportation network, routes are established between the locations, and the mode of connectivity is established between the locations. The global transportation network is represented as a network graph, with nodes representing locations, and the arcs between the nodes representing the routes. Transportation network represented as a network graph 102 is provided as input to the pre-process network graph component 104. The nodes and arcs are referred to as vertices and edges respectively in the network graph. Because the transportation network is considered at a global level, the network graph is typically complex with numerous nodes and arcs.

The network graph is preprocessed or preliminary processed by the pre-process network graph component 104. ‘Branch-removal’ is a method of pre-processing the network graph. Using ‘branch-removal’ technique, nodes with degree ‘1’ are identified, and removed from the network graph. Degree of a node in the network is the number of connections the node has with other nodes. For example, nodes with degree “1” has one connection with another node. The ‘branch-removal’ technique may be iteratively used to remove all the nodes with a defined minimum degree such as degree ‘1’, until the network graph is reduced and contains no node with degree ‘1’. Minimum degree such as degree ‘2’, etc., may be defined by a user. After preliminary processing the network graph, network partition solver 106 is used on the pre-processed network graph. Various graph partition algorithms such as b-balanced cut algorithm, min-cut algorithm, sparsest-cut algorithm, etc., may be used to partition the network graph. In graph partitioning method, a network graph is to be partitioned into two or more parts while balancing the sizes of the parts cut. Each part or partition represents a sub-graph. In the post-process network graph component 108, the nodes that were removed during ‘branch-removal’ are appended or added to the network graph, and this method is referred to as ‘branch-recovery’. Post-processing is referred to as subsequent processing of the network graph. After the ‘branch-recovery’ process, the partitioned sub-graphs are output in the form of a result table 110. For example, the nodes with degree “1” that were removed during ‘branch-removal’ are added to the network graph during ‘branch-recovery’.

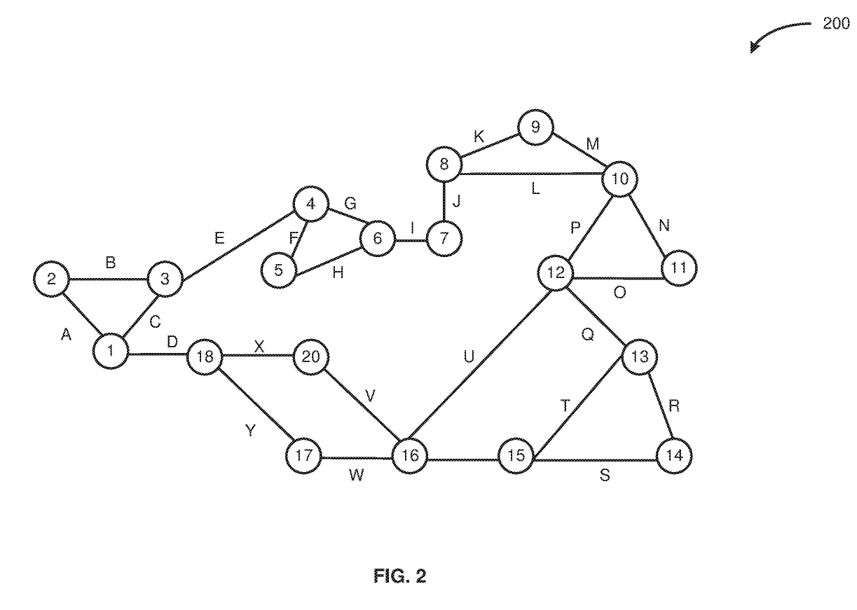

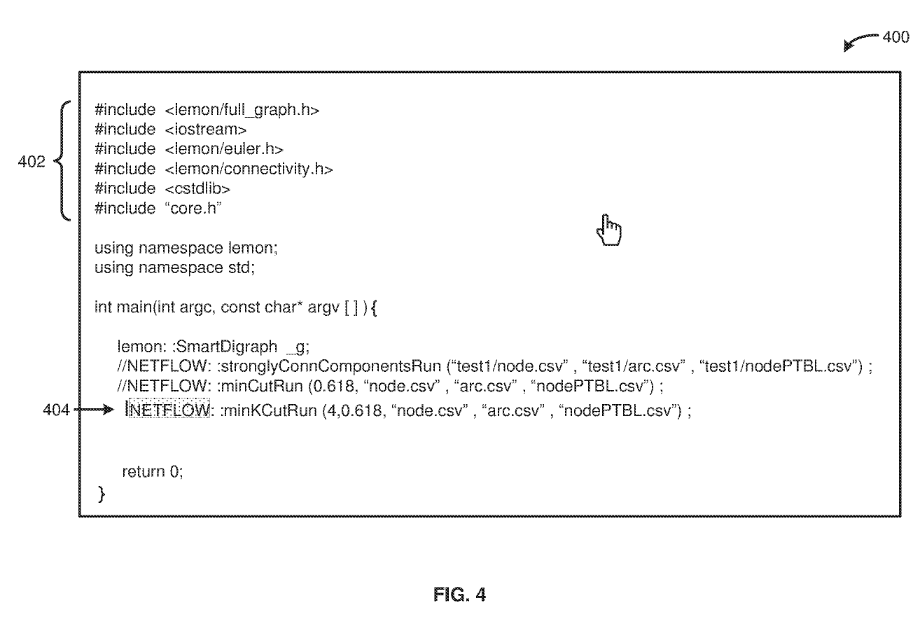

FIG. 2 is network graph 200 corresponding to a global transportation network, according to one embodiment. The network graph 200 is shown containing nodes corresponding to locations, and arcs corresponding to routes between the locations. Nodes ‘1’ to ‘20’ represent various locations, and the arcs ‘A’ to ‘Y’ connecting the nodes ‘1’ to ‘20’. Network graph (G) with nodes referred to as vertices (V), and arcs referred to as edges (E), are represented as set G (V, E). Weighted graph refers to a network graph where edges have weights or values. Given a positive integer k, let G:=(V, E) be a weighted graph with vertex set V and edge set E, and a k-separator of G is a subset of edges in E such that the removal of these edges would result in k sub-graphs of G, so that the connectivity among different sub-graphs is minimized. In one embodiment, the connectivity is the number of connections between different sub-graphs. The concept of k-separator extends to weighted graphs, where connectivity is measured by the aggregated weights of the edges contained in the separator instead. This method of partitioning is referred to as min-cut. The concept of k-balanced separator extends the definition of k-separator with special emphasis on the balancing of separated sub-graphs. In typical k-balanced cut all separated sub-graphs may have almost the same size, so that the network graph partition result is balanced. In order to achieve a strict balance, some explicit tolerance of error is set up for k-balanced cut. However, in the proposed k-balanced separator each divided partition is only approximately of size |V|/k, where |V| denotes number of vertices contained in the network graph. There's a tradeoff between the balanced separation and the min-cut algorithm. The illustrated network partition solver in FIG. 4 enables finding the most balanced cut among several min-cut solutions.

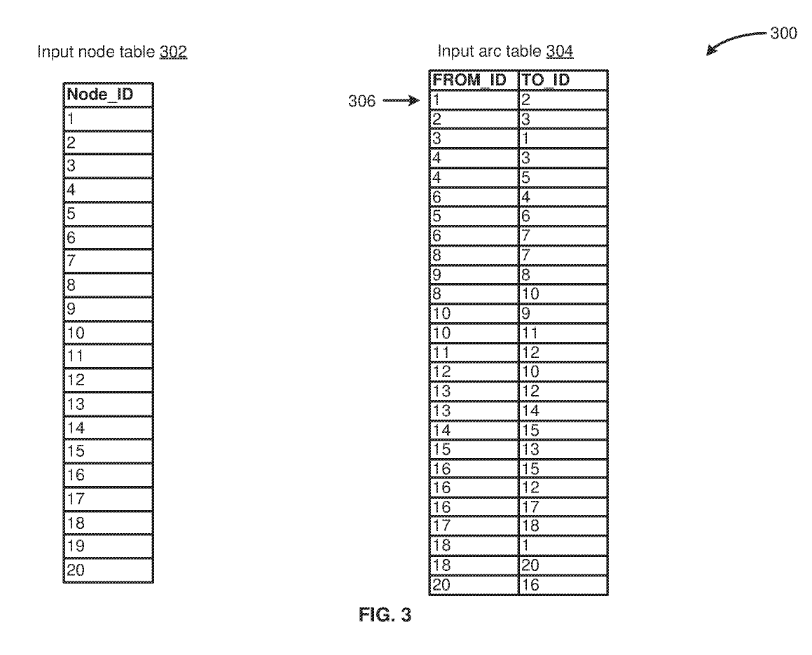

FIG. 3 illustrates input table set 300 including an input node table and an input arc table in transport resource planning, according to one embodiment. The nodes in the network graph 200 in FIG. 2 is represented as an input table, referred to as input node table 302. Node_id includes the node identifiers ‘1’ to ‘20’ in the input node table 302. Arcs ‘A’ to ‘Y’ connecting the nodes ‘1’ to ‘20’ are represented in the input arc table 304, as ‘From_Id’ and ‘To-Id’. For example, From_Id ‘1’ and To_Id ‘2’ represent arc ‘A’ as shown in row 306. Similarly, other entries are created in the input arc table 304, with ‘From_Id’ and ‘To-Id’ entered corresponding to the arcs in the network graph 200. For independent arcs in the network graph 200, the input arc table 304 is constructed with node identifiers in ‘From_Id’ and ‘To-Id’.

FIG. 4 is code snippet 400 illustrating network partition solver, according to one embodiment. Code snippet 400 is in computer programming language implementing min-cut algorithm. B-balanced cut algorithm may be used interchangeably with min-cut algorithm, since b-balanced cut algorithm includes min-cut algorithm as well. In b-balanced cut algorithm, sub-graphs of size ‘b’ are generated from the total number of vertices in the graph. ‘B’ may be provided as input during partitioning, and the sub-graphs partitioned occupy ‘b’ of the total number of vertices. Lines of code 402 are inclusion of standard libraries for programming. Function minKCutRun is a function implementing the min-cut network partition algorithm. Consider a graph G (V, E) with vertices or nodes with node identifiers ‘1’ to ‘20’, and arcs ‘A’ to ‘Y’ connecting the nodes ‘1’ to ‘20’. The nodes in the graph represented as an input node table, and the arcs connecting the nodes represented as an input arc table are provided as input to a minKCutRun function shown in line of code 404. MinKCutRun function takes input parameters such as number of partitions, a standard balance cut, input node table, input arc table, and an output table. The input parameters may be provided as number of partitions ‘4’, a standard balance cut is represented by numeral ‘0.618’, input node table is provided in a comma-separated values file format such as node.csv, input arc table is provided in a comma-separated values file format such as arc.csv, and an output table with partitions of graph is generated in a comma-separated values file such as nodepartitionlist.csv. The input parameters such as the number of partitions ‘4’ and the standard balance cut represented by numeral ‘0.618’ are referred to as partition criteria. Based on the partition criteria, number of partitions and the way in which partitions are generated is determined. Number of partitions is a numeral and can be received as input from a user, i.e., the number of partitions is user-defined. Standard balance cut may be a partition parameter, for example, standard balance cut of ‘0.5’, may balance the number of nodes in the partitions, i.e., sub-graphs.

The network graph is pre-processed or processed initially to reduce the computational complexity. ‘Branch-removal’ technique of pre-processing graphs involves removing branches i.e., paths that contains (i) at least one node with degree ‘1’, and (ii) other nodes having degree less than or equal to ‘2’. For pre-processing network graph, all nodes with degree ‘1’ are removed from the network graph. A reduced network graph with less number of nodes is obtained. This operation is iteratively repeated until the further reduced network graph contains no node with degree ‘1’. The pre-processed or preliminary processed network graph is provided as input to the network partition solver implementing algorithms such as min-cut or sparsest-cut to partition the graph into k sub-graphs with some algorithmic extensions. In the network partition solver, the concept of b-balanced cut as well as min-cut are utilized to obtain near-optimal balanced partitions. The idea of obtaining k-balanced partitions can be illustrated as a two-phase procedure. In the first phase, min-cut algorithm is applied to the larger sub-graphs or larger partitions repeatedly until the number of nodes occupied by each sub-graph constitutes approximately of the total number of nodes or less. In the second phase, a merging operation is performed for all small sub-graphs to obtain larger sub-graphs until the number of nodes of each merged sub-graph occupies approximately 1/k percentage of the total number of nodes. The complexity of this two-phase procedure is controlled during implementation. For instance, if nagamochilbaraki min-cut algorithm is used, then the worst-case complexity to find the k-balanced separator is O(|V|²|E|+|V|³log(|V|)), where V represents vertices, E represents edge and O represents the complexity. Output of the function MinKCutRun is an output table that includes partitioned sub-graphs.

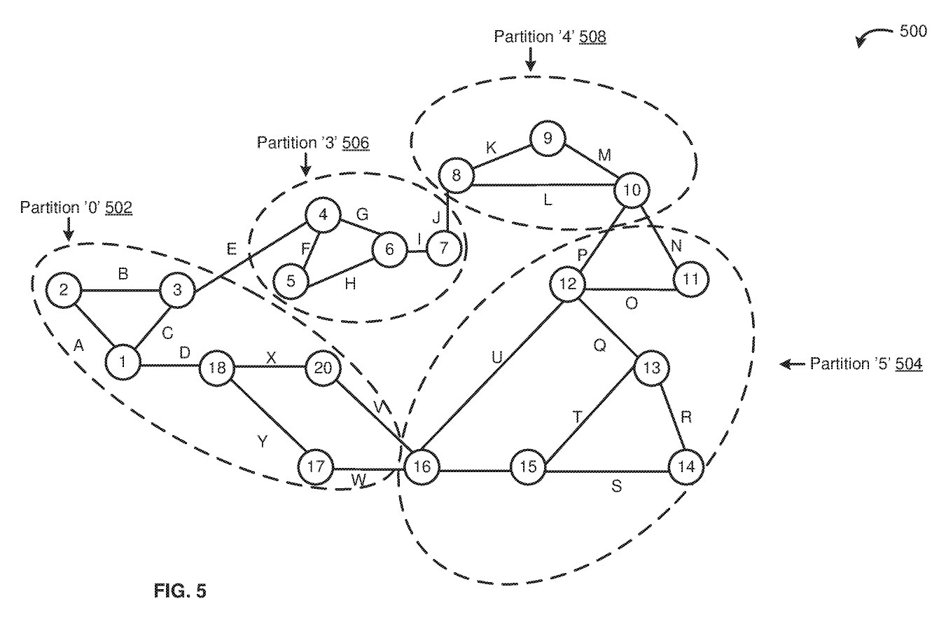

FIG. 5 is exemplary networks graph 500 illustrating partitions, according to one embodiment. When the preliminary processed graph is provided as input to function MinKCutRun, the network graph is partitioned as shown in the network graph 500. The graph is partitioned into ‘4’ partitions represented with partition identifiers ‘0’, ‘5’, ‘3’ and ‘4’. Nodes ‘2’, ‘3’, ‘17’, ‘18’ and ‘20’ are in first partition represented with partition identifier ‘0’, and is shown in the network graph as partition ‘0’ 502. Nodes ‘11’, ‘12’, ‘13’, ‘14’, ‘15’ and ‘16’ are in second partition represented with partition identifier ‘5’, and is shown in the network graph as partition ‘5’ 504. Nodes ‘4’, ‘5’, ‘6’, and ‘7’ are in third partition with partition identifier ‘3’, and is shown in the network graph as partition ‘3’ 506. Nodes ‘10’, ‘9’, and ‘8’ are in fourth partition represented with partition identifier ‘4’, and is shown in the network graph as partition ‘4’ 508.

In a scenario when a customer modifies a node in the network graph, the network partition solver enables route re-generation in the specific sub-graph and not in the entire network graph. This eliminates re-computation of the routes in the complete network graph. Since the network graph is partitioned into several sub-graphs, the routes within the individual sub-graphs are computed in parallel to reduce the computational complexity. Changes or modification to the network graph are referred to as delta changes. Delta changes to the network graph may be to update the optimal route set when some segments of routes are added, deleted, or modified in the network graph. As intermodal network changes dynamically due to the schedule update and cost change, route-planning service offers a manual modification function to customers to add/delete routes and modifies parameters on routes. Modification may be in the nodes representing physical locations in the network graph. Partition corresponding to the modified node is identified, and the routes in the identified partition are re-computed. Therefore, only partition corresponding to the modified node is re-computed and not the entire network graph. Without the help of graph partitioning method or network partition solver, any change in the network graph could lead to re-calculation of the entire network graph, and therefore computing resource and time is wasted. The network graph represents a topology for global transportation that may be used an intermodal container or vehicle for transportation of freight.

Certain nodes act as gateway to the partitions, such as node ‘3’ acts as gateway to partition ‘0’, node acts as gateway to partition ‘5’, node ‘4’ acts as gateway to partition ‘3’, and node ‘10’ acts as gateway to partition ‘4’. A partition may have one or more gateways, for example, node ‘20’ or node ‘17’ may acts as a gateway to partition ‘5’. The network partition solver may automatically determine gateway nodes. In the scenario where node ‘20’ or node ‘17’ may acts as a gateway to partition ‘5’, the selection of gateway node may be automatically determined based on one or more factors. Some of the factors include a node with high throughput in the partition, a node with sum of minimum distance to other nodes in the partition, a node that can connect to the rest of the nodes in the partition with least cost, etc. The factors depend on the algorithm implemented by the network partition solver. When the number of gateway nodes in a partition increases, computational complexity of the network partition solver increases. Therefore, the factors described above help determining few gateway nodes in the partition. When the modification is on the nodes that act as gateway to partition, the network flow solver is executed to re-compute the, partitions. However, when there is a modification on nodes other than gateway nodes, such as node ‘2’, routes are recomputed only in partition ‘0’, and no other partitions are affected. Similarly, if nodes ‘18’ and ‘6’ are modified, routes in partition ‘0’ and ‘3’ are re-computed in parallel without affecting the complete network graph.

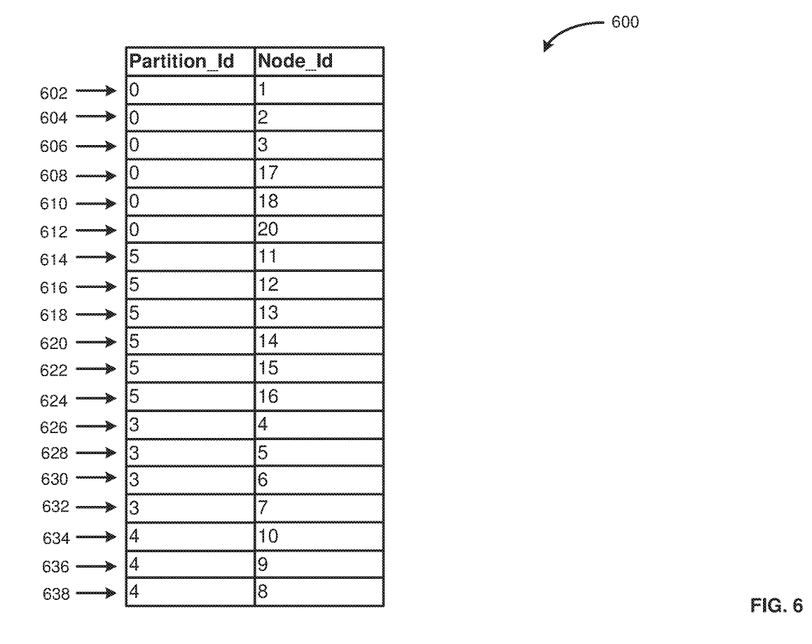

FIG. 6 is output table 600 illustrating partition of the graph, according to one embodiment. The output table 600 shows the output of the mincut function. Output table has partition identifiers and node identifiers. The graph is partitioned into ‘4’ partitions represented with partition identifiers ‘0’, ‘5’, ‘3’ and ‘4’. Nodes ‘1’, ‘2’, ‘3’, ‘17’, ‘18’ and ‘20’ are in first partition represented with partition identifier ‘0’, and is shown in the output table in rows 602 to 612. Nodes ‘11’-‘16’ are in second partition represented with partition identifier ‘5’, and is shown in the output table in rows 614 to 624. Nodes ‘4’, ‘5’, ‘6’, and ‘7’ are in third partition with partition identifier ‘3’, and is shown in the output table in rows 626 to 632. Nodes ‘10’, ‘9’, and ‘8’ are in fourth partition represented with partition identifier ‘4’, and is shown in the output table in rows 634 to 638.

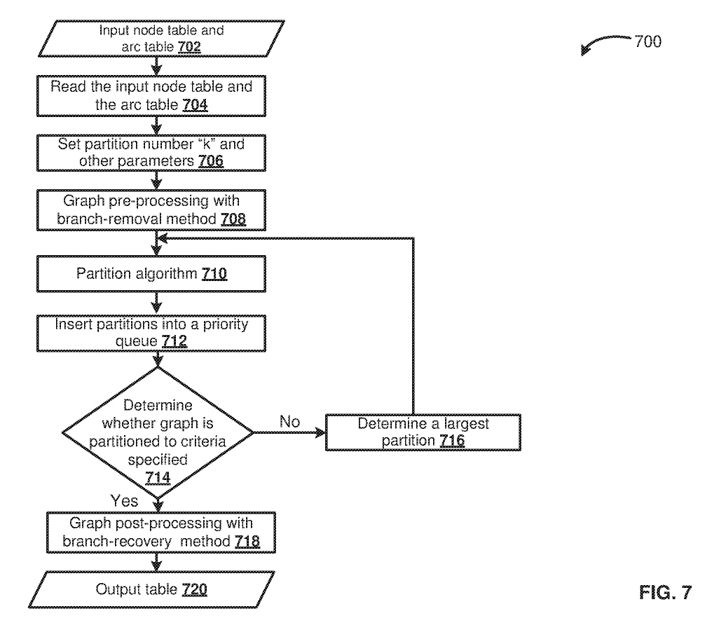

FIG. 7 is a flow chart 700 illustrating applying network partition algorithm to nodes, according to one embodiment. Node table and arc table are received as input in 702. For example, input node table 302 and input arc table 304 described in FIG. 3 may be used as node table and arc table. At 704, the node table and the arc table are read as input. At 706, a partition number ‘k’ and other parameters are set. For example, the partition number may be ‘4’ representing the number of partitions, and other parameters may include a partition parameter such as standard balance cut of ‘0.5’. These partition parameters are referred to as partition criteria. At 708, graph pre-processing is performed using the branch-removal method on the node table and arc table received. For example, using the branch-removal technique branches of nodes with degree ‘1’ is removed. At 710, the preliminary processed graph is input to a partition algorithm, and partitions are generated. For example, the preliminary processed graph is input in a network partition solver explained in FIG. 4, and the partitions may be generated as explained in FIG. 5. At 712, the generated partitions are inserted into a priority queue. At 714, it is determined whether the graph is sufficiently partitioned to meet the partition criteria specified. Upon determining that the graph is not sufficiently partitioned, at 716, a largest partition is identified, and provided as input to the block 710, and the process 710 to 714 is repeated. The large partition above a pre-defined threshold is identified for further partitioning. At 718, the partitions in the graph is subsequently processed using the branch-recovery method where the nodes that were removed during ‘branch-removal’ are appended or added to the graph, and this method is referred to as ‘branch-recovery’. After the ‘branch-recovery’ process, the partitioned graphs are output in the form of a result table 720.

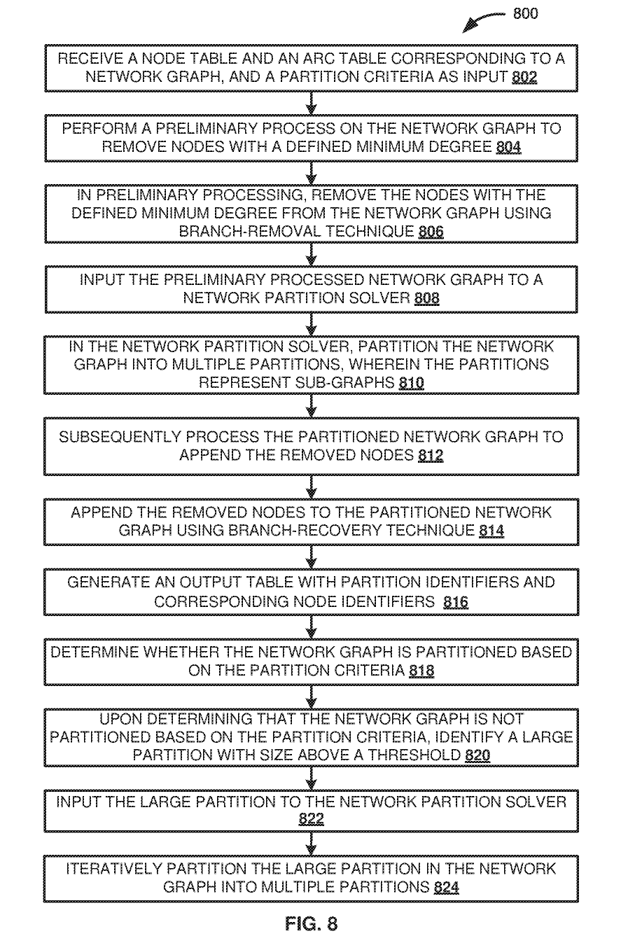

FIG. 8 is a flow chart 800 illustrating network separator in transportation resource planning, according to one embodiment. At 802, a node table and an arc table corresponding to a network graph, and partition criteria are received as input. For example, input node table 302 and input arc table 304 described in FIG. 3 may be used as node table and arc table. At 804, a preliminary process is performed on the network graph to remove nodes with a defined minimum degree. For example, input parameters such as the number of partitions ‘4’ and the standard balance cut represented by numeral ‘0.618’ are received as partition criteria. Based on the partition criteria, number of partitions and the way in which partitions are generated is determined. At 806, in preliminary processing, the nodes with the defined minimum degree are removed from the network graph using branch-removal technique. For example, using the branch-removal technique branches of nodes with degree ‘1’ is removed. At 808, the preliminary processed network graph is input to a network partition solver. At 810, in the network partition solver, the network graph is partitioned into multiple partitions. The partitions represent sub-graphs. For example, the preliminary processed network graph is input in the network partition solver explained in FIG. 4, and the partitions may be generated as explained in FIG. 5. At 812, the network graph is subsequently processed to append the removed nodes. At 814, the removed nodes are appended to the network graph using branch-recovery technique. At 816, an output table is generated with partition identifiers and corresponding node identifiers. For example, an output table 600 as described in FIG. 6 may be generated. At 818, it is determined whether the network graph is partitioned based on the partition criteria. At 820, upon determining that the network graph is not partitioned to meet the partition criteria, a large partition with size above a threshold is identified. For example, the threshold for the large partition may be set as ‘50’ nodes. Any partition with nodes greater than ‘50’ nodes may be identified as large partition or large sub-graph. At 822, the large partition is input to the network partition solver. At 824, the large partition in the network graph is iteratively partitioned into multiple partitions until the partition criteria are met.

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

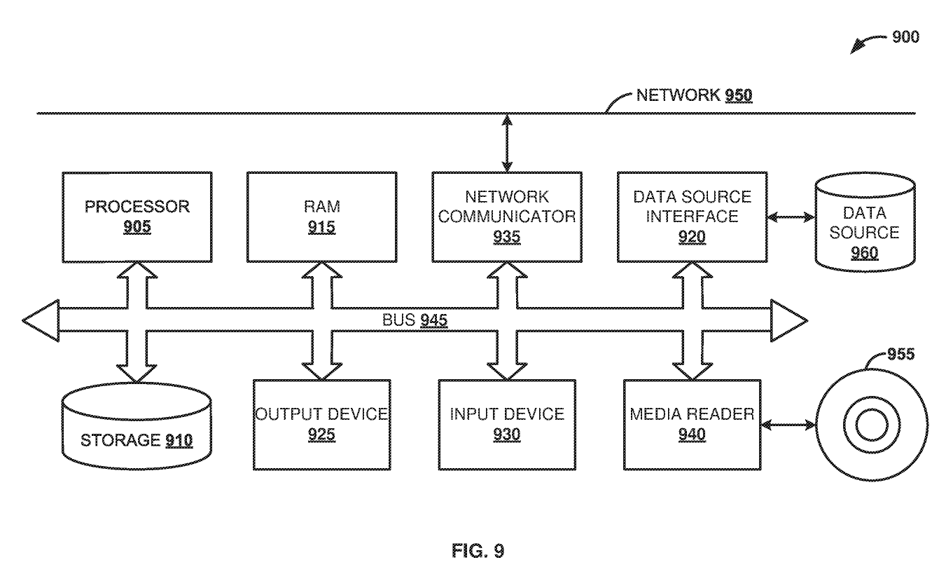

FIG. 9 is a block diagram of an exemplary computer system 900. The computer system 900 includes a processor 905 that executes software instructions or code stored on a computer readable storage medium 955 to perform the above-illustrated methods. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as a semantic layer.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive a node table and an arc table corresponding to a network graph, and partition criteria as input, wherein nodes in the node table and arcs in the arc table form the network graph;
perform a preliminary process on the network graph to remove nodes included in the node table with a defined minimum degree included in the partition criteria;
input the processed network graph to a network partition solver;
in the network partition solver, partition the network graph into multiple partitions, wherein the partitions represent sub-graphs;
perform a subsequent process on the partitioned network graph to append the removed nodes to the network graph; and
generate an output table with partition identifiers and corresponding node identifiers.

2. The computer-readable medium of claim 1, further comprises instructions which when executed by the computer further cause the computer to:
determine whether the network graph is partitioned based on the partition criteria;
upon determining that the network graph is not partitioned based on the partition criteria, identify a large partition with size above a threshold;
input the large partition to the network partition solver; and
iteratively partition the large partition in the network graph into multiple partitions.

3. The computer-readable medium of claim 1, wherein the preliminary process on the network graph further comprises:
remove nodes with the defined minimum degree from the network graph using branch-removal technique.

4. The computer-readable medium of claim 1, wherein the subsequent process on the network graph further comprises:
append the removed nodes to the network graph using branch-recovery technique.

5. The computer-readable medium of claim 1, further comprises instructions which when executed by the computer further cause the computer to:
compute routes within each of the partitions in parallel.

6. The computer-readable medium of claim 1, further comprises instructions which when executed by the computer further cause the computer to:
receive modification in nodes in the network graph;
identify a partition corresponding to the modified node; and
compute routes in the identified partition.

7. The computer-readable medium of claim 2, partition the network graph further comprises:
iteratively apply b-balanced cut algorithm to the large partitions.

8. A computer-implemented method of network separator for transport resource planning, the method comprising:
receive a node table and an arc table corresponding to a network graph, and partition criteria as input;
perform a preliminary process on the network graph to remove nodes include the node table with a defined minimum degree included in the partition criteria;
input the processed network graph to a network partition solver;
in the network partition solver, partition the network graph into multiple partitions, wherein the partitions represent sub-graphs;
perform a subsequent process on the partitioned network graph to append the removed nodes to the network graph; and
generate an output table with partition identifiers and corresponding node identifiers.

9. The method of claim 8, further comprising:
determine whether the network graph is partitioned based on the partition criteria;
upon determining that the network graph is not partitioned based on the partition criteria, identify a large partition with size above a threshold;
input the large partition to the network partition solver; and
iteratively partition the large partition in the network graph into multiple partitions.

10. The method of claim 8, wherein the preliminary process on the network graph further comprising:
remove nodes with the defined minimum degree from the network graph using branch-removal technique.

11. The method of claim 8, wherein the subsequent process on the network graph further comprising:
append the removed nodes to the network graph using branch-recovery technique.

12. The method of claim 8, further comprising:
compute routes within each of the partitions in parallel.

13. The method of claim 8, wherein generating composed retention attribute, further comprising:
receive modification in nodes in the network graph;
identify a partition corresponding to the modified node; and
compute routes in the identified partition.

14. The method of claim 9, partition the network graph further comprising:
iteratively apply b-balanced cut algorithm to the large partitions.

15. A computer system for network separator for transport resource planning, comprising:
a computer memory to store program code; and
a processor to execute the program code to:
receive a node table and an arc table corresponding to a network graph, and partition criteria as input;
perform a preliminary process on the network graph to remove nodes included in the node table with a defined minimum degree included in the partition criteria;
input the processed network graph to a network partition solver;
in the network partition solver, partition the network graph into multiple partitions,
wherein the partitions represent sub-graphs;
perform a subsequent process on the partitioned network graph to append the removed nodes to the network graph; and
generate an output table with partition identifiers and corresponding node identifiers.

16. The system of claim 15, wherein the processor further executes the program code to:
determine whether the network graph is partitioned based on the partition criteria;
upon determining that the network graph is not partitioned based on the partition criteria, identify a large partition with size above a threshold;
input the large partition to the network partition solver; and
iteratively partition the large partition in the network graph into multiple partitions.

17. The system of claim 15, wherein the preliminary process on the network graph further executes the program code to:
remove nodes with the defined minimum degree from the network graph using branch-removal technique.

18. The system of claim 15, wherein the subsequent process on the network graph the processor further executes the program code to:
append the removed nodes to the network graph using branch-recovery technique.

19. The system of claim 18, wherein the processor further executes the program code to:
compute routes within each of the partitions in parallel.

20. The system of claim 19, wherein the processor further executes the program code to:
receive modification in nodes in the network graph;
identify a partition corresponding to the modified node; and
compute routes in the identified partition.
